(19) United States
(12) Patent Application Publication
(10) Pub. No.: US 2011/0238502 A1
(43) Pub. Date: Sep. 29, 2011

(54) SYSTEM FOR INTELLIGENT REAL TIME INFORMATION SERVICE AND METHOD OF THE SAME

(76) Inventors: Jyun-Jhe Hung, Taichung (TW); Chi-Hsuan Wu, Taichung (TW); Sheng-Tsung Hou, Taichung (TW); Wei-Lung Chen, Taichung (TW)

(21) Appl. No.: 12/731,031

(22) Filed: Mar. 24, 2010

(51) Int. Cl. G06F 17/30; G06Q 30/00

(52) U.S. Cl. 705/14.62; 707/769; 707/802; 707/E17.014; 707/E17.044; 707/E17.005

(57) ABSTRACT

A service method for real time information compares surrounding information provided by a transportation with conditional factors established in a database. A service center provides the real time information that conforming to the conditional factors to the transportation. Thence the transportation could respectively present the real time information on a multimedia display unit installed thereon. Whereby, the service center provides a corresponding real time information in accordance with the provided surrounding data around the transportation, and introduces the concept of time and region separation to preferably supply proper real time information to different users.

### BACKGROUND OF THE INVENTION

1. Field of the Invention

The present invention relates to a service about real time information, in particular to a system and a method for providing the corresponding service about the intelligent real time information according to the data surrounding a transportation.

2. Description of the Related Art

Generally, various types of advertisement are used to attract people and leave messages. For example, fixed billboards like the T-bars standing beside the high-way, placards posted in front of stores, or large electronic displays are all popular forms for advertisement. In addition, commercials on TV, on the public transportations, or on the key-word search on Internet are also commonly applied to strengthen the commercial effect.

However, afore advertisement forms are aimlessly and extensively broadcasted to people, the advertising service tallying with certain group or category that have the same habits usually could not be directly read by the aimed group. Therefore, a large investment on the advertisement from advertisers often turns out in vain. Thus, the present invention is accordingly developed.

### SUMMARY OF THE INVENTION

The present invention comprises steps as follows: A. The real time information surrounding transportation is established; B. A service center builds the real time information surrounding the transportation; C. Comparison is processed; D. The real time information is downloaded by the transportation; and E. The real time information on the transportation is updated. The system of the present invention comprises a transportation and a service center. Wherein, the transportation utilizes a data processing unit to process, receive, and apply first involved data from an orientation system, a transportation communication system, and at least one multimedia display units respectively connecting therewith. Moreover, the service center further utilizes a service data processing unit to receive, process, and apply the involved data from a service communication system, a multimedia processing unit, and a main database respectively connecting therewith.

Accordingly, the present invention enhances the service center to compare the retrieved real time information surrounding the transportation with a conditional factor established in the main database. Whereby, the service center could thence provide the appropriate real time information that conforms to the conditional factors to the transportation. Hence, the corresponding real time information could be respectively shown on a driver displayer, a customer displayer, and a third party displayer through the multimedia display units on the transportation. That is to say, the service center not only provides the matching real time information in correspondence with the surrounding environment of the transportation but offers consumers the instant messages according to dynamic regional and time categories of the transportation. Namely, when the transportation is at a certain position and time, the related real time information would be timely provided to users, and the service center could also provide different users with suitable messages.

### BRIEF DESCRIPTION OF THE DRAWINGS

FIG. 1 is a flowchart showing the steps of the present invention;

FIG. 2 is a flow chart showing the executive procedure of the present invention;

FIG. 3 is a schematic view showing the present invention;

FIG. 4 is a schematic view showing the transportation applied in the present invention;

FIG. 5 is another schematic view showing the present invention;

FIG. 6 is a schematic view showing the present invention applied in the different areas within a same time section; and

FIG. 7 is a schematic view showing the present invention applied in a same area within different time sections.

### DETAILED DESCRIPTION OF THE PREFERRED EMBODIMENTS

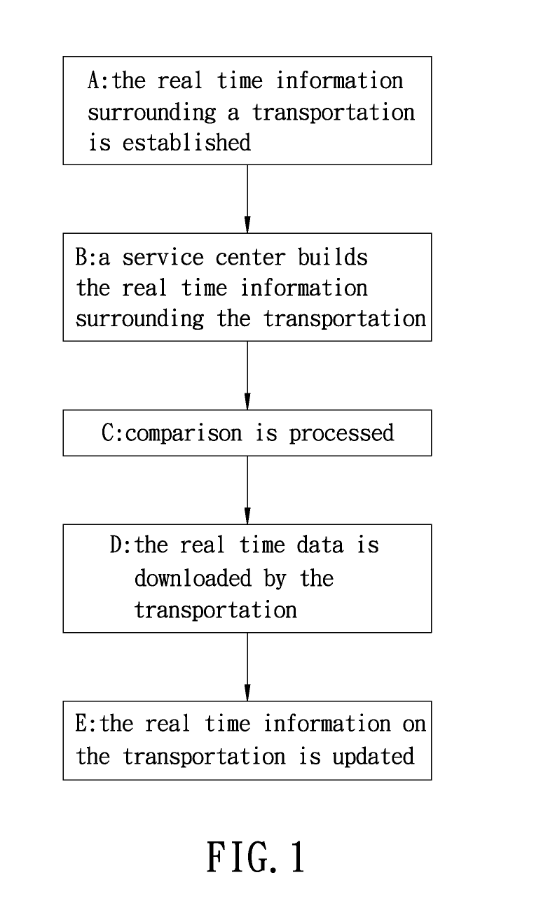

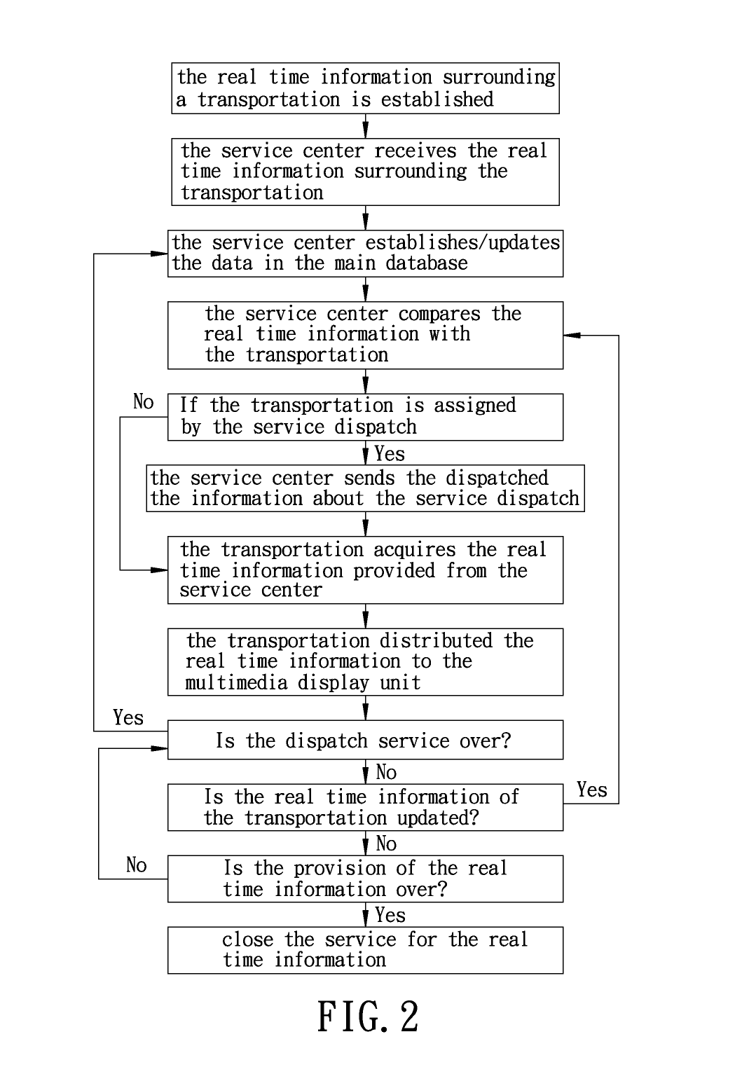

FIGS. 1 to 3 show the flowcharts and a schematic view of the system of the present invention. The method of the present invention comprises steps as follows:
A. The real time information surrounding a transportation is established: the transportation 10 provided with the real time information including a transportation data processing unit 11, an orientation system 12, a transportation communication system 13, and at least one multimedia display unit 14. Wherein, the surrounding information of the transportation 10 is generated through orientation system 12 on a basis of the instant time and location around the transportation 10. For example, an actual location of transportation 10 could be defined via the orientation system 12, or the location of the transportation 10 could also be obtained via instant environmental information like the weather at a place which the transportation is located, which is so-called the real time information surrounding the transportation.
B. A service center builds the real time information surrounding the transportation: the service center 20 utilizes a service data processing unit 21 for processing the real time information surrounding the transportation 10 received via a service communication system 22, and the real time information would be accessed in a main database 23 of the service center 20, so that the service center 20 could preferably build every real time information indicating the dynamic data of the transportation 10. Wherein, a relative executive procedure adapting to the present service method of intelligent real time information would be saved in the main database 23, and at least one real time information and conditional factor preset by the real time information would be saved in the database 23 for being offered to the transportation 10;
C. Comparison is processed: the service center 20 compares the conditional factor saved in the database 23 with the real time information surrounding the transportation 10 built in the database 23. Whereby, a designated transportation 10 that conforms to the corresponding conditional factor would be selected according to the provided real time information surrounding the transportation 10;
D. The real time information is downloaded by the transportation: the service center 20 would firstly confirm if the transportation 10 is assigned by any distributed service dispatch. If no distributed service dispatch is assigned to the transportation 10, the real time information with a compared result would be transmitted to correspondent transportation 10 by the service center 20 through the service communication system 22. If any distributed service dispatch is concurrently assigned to the transportation 10, the service center 20 would get a service dispatch message from the database 23. Then the service dispatch as well as the compared real time information would be transmitted to the transportation 10. Thereby, the transportation 10 would receive the real time information through the transportation communication system 13. Thence, the multimedia display units 14 that are installed on the transportation 10 could display the real time information thereon. Further, the multimedia display unit 14 includes a driver displayer 141, a customer displayer 142, and a third party displayer 143. According to different users, the service center would provide the suitable real time information to the corresponding users. Moreover, the transportation data processing unit 11 of the transportation 10 respectively presents the information on the driver displayer 141, the customer displayer 142, and the third party displayer 143 of the multimedia display units 14. Wherein, in this embodiment, the service dispatch substantially includes a conveyance service, a multimedia service, and a basic service. The conveyance service further includes at least a mission data and a customer data that could be presented on the driver displayer 141. The multimedia service further includes at least a one-way advertisement and an interacting advertisement that could be presented on the customer displayer 142. The third party displayer 143 is mainly employed to provide the one-way advertisement with real time information to an casual person. Additionally, the service dispatch could be also varied in service according to the transportation 10, like cargos transport;
E. The real time information on the transportation is updated: the service center 20 would execute a new comparison in regard to the updated real time information being saved in the database 23 in accordance with the transportation 10. The real time information surrounding the transportation 10 discrepant to the original conditional factor would trigger the service center 20 to restart the comparison, and the newly-matched real time information corresponding to the conditional factor would be re-transmitted to the transportation 10, so that the transportation 10 could update different real time information according to the corresponding surrounding data, and the newly-matched real time information could be displayed on the multimedia display units 14 in time. Wherein, the transportation 10 concurrently records users' operational habits on the multimedia service, and the service center 20 would renew the recording in the main database 23 while re-updating the real time information.

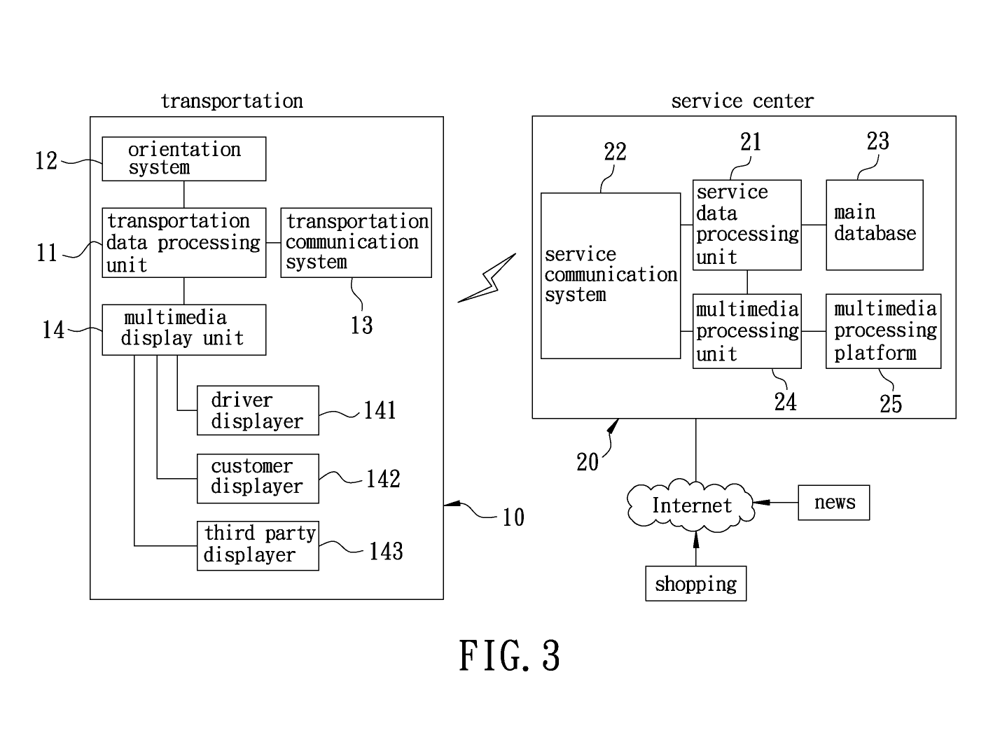

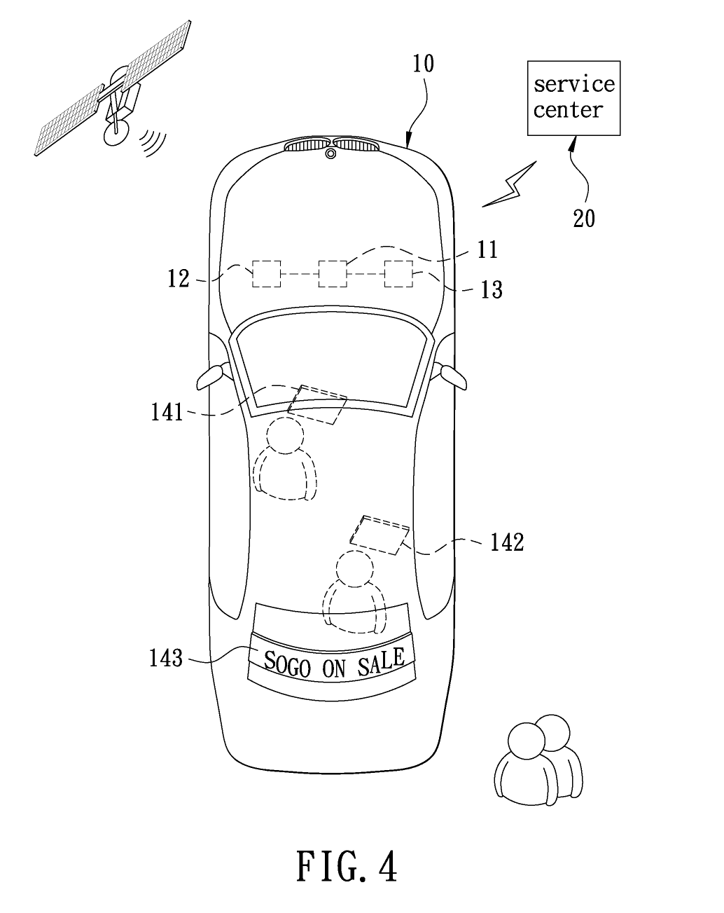

FIGS. 3 and 4 show the schematic views of the present invention and a frame of the transportation. The system of the present invention comprises as follows:

A transportation 10 includes a transportation data processing unit 11, an orientation system 12, a transportation communication system 13, and at least one multimedia display units 14 are respectively connected to the transportation data processing unit 11. Herein, the multimedia display unit 14 further includes a driver displayer 141, a customer displayer 142, and a third party displayer 143. The first and customer displayers 141, 142 are used to present the real time information to the person inside the transportation 10, and the third party displayer 143 is used to present the real time information to the person outside the transportation 10. Wherein, the transportation data processing unit 11 receiving a piece of real time surrounding information from the orientation system 12 allows the real time surrounding information to be established on the transportation 10, so that the transportation communication system 13 would be applied to receive and transmit the information. As to the multimedia display unit 14, it could display the real time information that is processed and decoded by the transportation data processing unit 11;

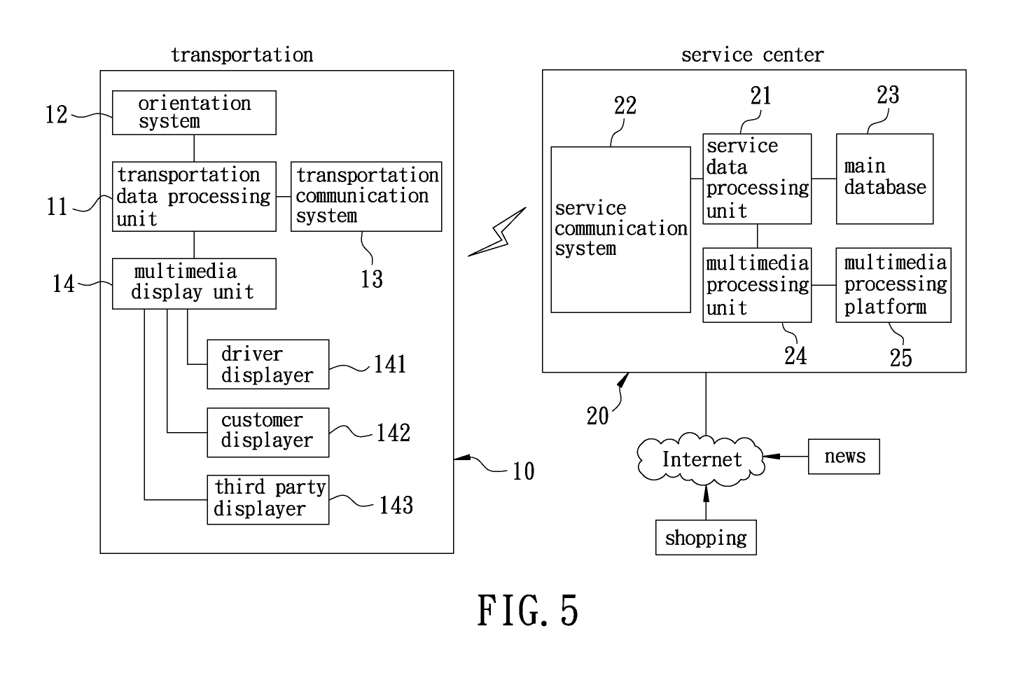

A service center 20 includes a service data processing unit 21 to receive, process, and employ a received data. The service data processing unit 21 further connects with a service communication system 22, a main database 23, and a multimedia processing unit 24. Wherein, the service communications system 22 is employed to receive and transmit data, the multimedia processing unit 24 is employed to process multimedia data, and the main database 23 is employed to establish the real time information surrounding the transportation, instant information, and related conditional factors that are going to be supplied. Additionally, the multimedia processing unit 24 further connects to a multimedia processing platform 25. The platform 25 could receive and process a piece of external multimedia information via Internet. Herein, the multimedia information substantially includes news, shopping discounts, advertisement, etc. Thus, after the multimedia information is processed by the multimedia processing unit 24, the multimedia information would be directly transmitted to the transportation 10 via the service communication system 22. Referring to FIG. 5 showing the other preferred embodiment of the present invention has the same frame and characteristics as that of the previous embodiment; thus, the familiar techniques are herein omitted. In this embodiment, the multimedia processing unit 24 of the service center 20 further connects to a multimedia processing platform 25. The platform 25 could receive and process apiece of external multimedia information via Internet, so that after the multimedia information is processed by the multimedia processing unit, the multimedia information would be processed and employed by the service data processing unit 21 for transmitting to the transportation 10 via the service communication system 22.

Accordingly, the real time information that is established by the orientation system 12 would be transmitted to the service center 20 via the transportation 10. Thence the service center 20 would access the real time information in the database 23. Thus, the service center 20 introduces a concept of dividing time and regional to cooperate with the real time information that is established in the database 23 through the transportation. Hence, the service data processing unit 21 for the service center would compare the established information with the accessed information. As a result, the service center 20 could provide the transportation 10 with suitable real time information that tallies with the conditional factors. Thence, a compared result would be accordingly transmitted to the transportation communication system 13 by the service center 20, and the transportation data processing unit 11 would transmit the received data from the transportation communication system 13 to the correspondent multimedia display unit 14 after being processed and decoded, so that an appropriate service with the real time information provided by the transportation 10 could be provided.

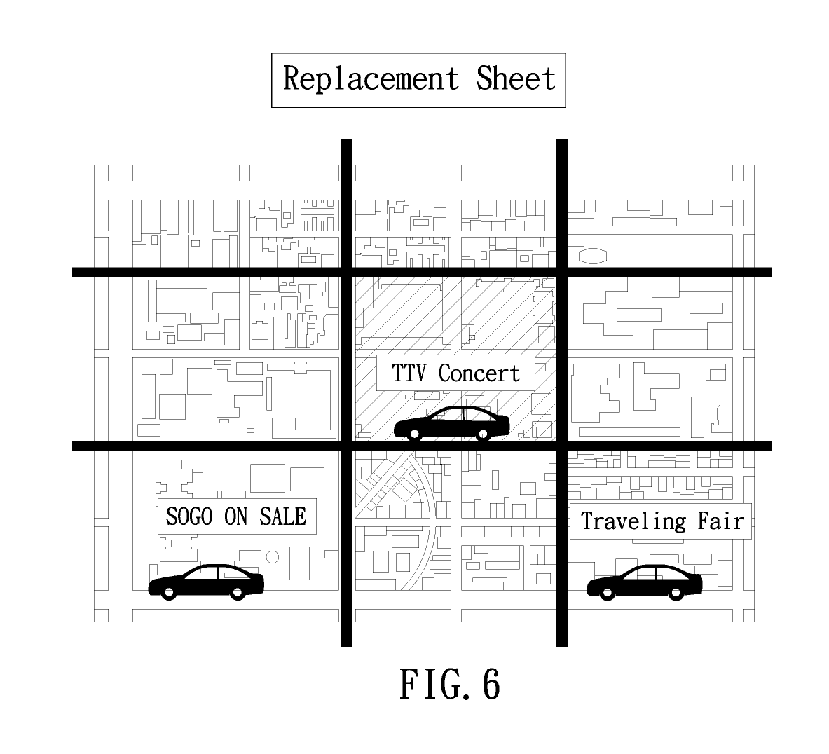

FIG. 6 shows plural transportation 10 in a certain area that could provide the real time information. In this embodiment, there are three vehicles 10. Wherein, each vehicle 10 could establish the real time information therearound through the orientation system 12 installed thereon. Herein, the information surrounding the vehicle 10 is generated on a basis of the vehicle 10's instantaneous time and location. Further referring to FIGS. 1 to 4, after the real time surrounding information is processed by the transportation data processing unit 11, the transportation communication system 13 would further allow the processed information to be transmitted to the service center 20. Accordingly, the service communicating system 22 would receive the information from the vehicle 10 and further transmit the same to the service data processing unit 21. Whereby, the service data processing unit 21 saves the real time surrounding information provided by the vehicles 10 in the database 23; concurrently, the service data processing unit 21 would compare the received real time surrounding information from the vehicle 10 with the conditional factors set in the database 23. In time of comparison, the service center 20 also has to confirm if there is correspondent service dispatch, such as the conveyance service. If there is service dispatch provided, the service center 20 would concomitantly transmit the real time information together with the same service dispatch to the vehicle 10. Subsequently, the vehicle 10 receives the message via the transportation communication system 13, and the message is processed by the transportation data processing unit 11. The real time information would be thence respectively sent to the matching multimedia display unit 14. Namely, the driver displayer 141 would present the mission data along with the customer data, like the coordinates of leaving and destination of the transportation. As to the customer displayer 142, the one-way advertisement and the interacting advertisement would be displayed thereon. In the one-way advertisement, users could only read the real time information; in the interacting advertisement, users could read different contents that just fit them, and at the same time, users could decide whether to interact with the multimedia. On the other hand, the third party displayer 143 would present the real time information to random people outside the vehicle 10, and the presentation mainly adopts the one-way advertisement.

When the vehicles 10 that provide the real time information are orientated by the orientation system 12, the service center 20 could handily monitor positions of the vehicles 10, and corresponding real time information and services could be promptly provided to the vehicles 10 according to the provided surrounding information therefrom. Thence, when the vehicle 10 updates the real time surrounding information, the service data processing unit would distinguish whether the information in the transportation is still consistent with the original conditional factor. Discrepant comparison would carry out a new comparison for the subsequent updated real time information. After sending the dispatched mission to the vehicle, the vehicle could not only update the real time surrounding information but also access users' operational habits on the multimedia display unit in the database. Whereby, the saved data and the customers' basic data could be served as a certain conditional factor for a new comparison in the future.

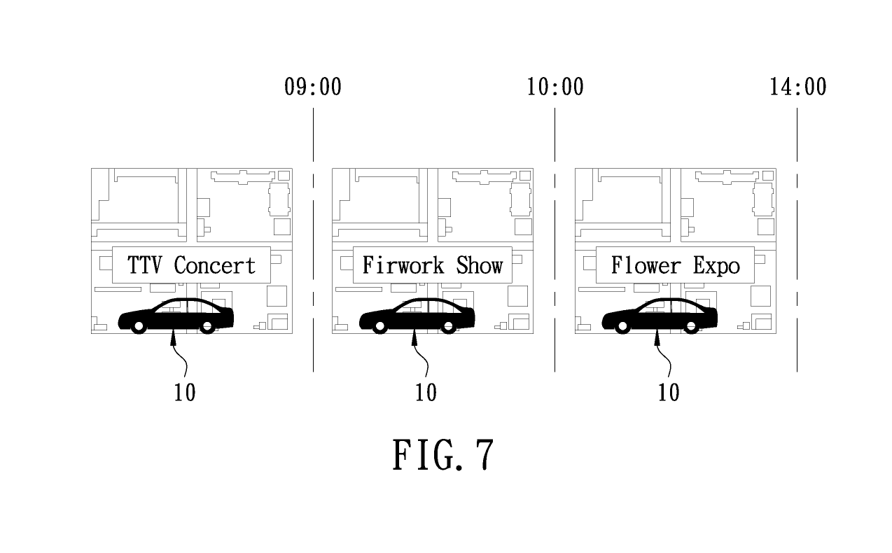

Referring to FIGS. 6 and 7, each of the transportation 10 providing the real time information could offer individual real time information that is suited with the conditional factor when the transportations are located at the same area with different time sections, or at different areas with the same time section. Referring to FIG. 6, the service center 20 gives different real time information in view of the transportations 10 being located on different positions at the same time. Whereby, the real time information is served in accordance with regions. Referring to FIG. 7, the service center gives different real time information in view of the transportations being located on the same position at the different time sections. Whereby, the real time information is served in accordance with the time sections. Alternatively, the present invention utilizes the customer displayer 142 to perform the interaction with customers. Moreover, the interacting data would be saved in the database 23. As a result, the service center 20 could timely offer the matching real time information that tallies with the conditional factor even if the transportations 10 show up in a certain area by different time sections, or in different areas by the same time section. Whereby, the present invention offers the real time information in accordance with the suitable time and region for preferably advancing the service efficiency.

I claim:

1. A service method for providing intelligent real time information comprising steps of:
A. said real time information surrounding a transportation being established: said transportation provided with said real time information including a transportation data processing unit, an orientation system, a transportation communication system, and at least one multimedia display unit; whereby, said transportation would establish said real time information therearound via said orientation system;
B. a service center building said real time information surrounding said transportation: said service center receiving said real time information surrounding said transportation received via a service communication system, and said real time information would be accessed in a main database of said service center; whereby, said service center would establish said real time information surrounding said transportation according to the provided instant information; wherein, a relative executive procedure would be saved in said main database, and at least one real time information and conditional factor preset by the real time information would be saved in said database for being offered to said transportation;
C. comparison being processed: said service center comparing said conditional factor saved in said database with said real time information surrounding said transportation built in said database; whereby, a designated transportation that conforms with corresponding conditional factor would be selected according to said provided real time information surrounding said transportation;
D. said real time information being downloaded by said transportation: said real time information with a compared result would be transmitted to correspondent transportation by said service center through said service communication system, so that said transportation would receive said real time information through said transportation communication system; thence, said multimedia display units that are installed on said transportation could display said real time information; and
E. said real time information on said transportation being updated: said service center would execute a new comparison when said updated real time information is saved in said database; real time information surrounding said transportation discrepant to an original conditional factor would trigger said service center to restart said comparison, and said newly-matched real time information corresponding to said conditional factor would be re-transmitted to said transportation, so that said transportation could update different real time information according to the corresponding surrounding data, and said newly-matched real time information could be displayed on said multimedia display units in time;
wherein, said service center introducing a concept of dividing time and region for said real time information to be established in said database; thereby, in accordance with said surrounding data, said service center would send an appropriate real time information tallying with said conditional factor to said transportation, and said real time information would be shown on said multimedia display units, so that a service for providing real time information on a transportation being accomplished.

2. The method as claimed in claim 1, wherein, while said transportation is downloading said real time information in step D, and said transportation is assigned by a distributed service dispatch from said service center, said service center would automatically get a service dispatch message from said database, and said assigned information would be transmitted to said transportation.

3. The method as claimed in claim 2, wherein, said service dispatch includes a conveyance service, a multimedia service, and a basic service; wherein, said assigned information from said conveyance service further has a mission data and a customer data, and said assigned information from said multimedia service further has a one-way advertisement and an interacting advertisement.

4. The method as claimed in claim 3, wherein, said transportation concurrently records users' operational habits on said multimedia service, and said service center would renew said recording in said main database while re-updating said real time information.

5. The method as claimed in claim 1, wherein, said information surrounding said transportation is generated on a basis of said transportation's instantaneous time and location.

6. The method as claimed in claim 1, wherein, said conditional factor of said real time information substantially includes an instantaneous time, an instantaneous location, and customers' basic data.

7. The method as claimed in claim 1, wherein, said multimedia display unit further includes a driver displayer, a customer displayer, and a third party displayer.

8. The method as claimed in claim 7, wherein, said service center provides different users with fitting real time information; while said transportation is downloading, received real time information would be sorted by users, and suitable information would be displayed on said driver displayer, said customer displayer, and said third party displayer; thence, said appropriate real time information would be respectively sent to a driver, a customer, and a random person.

9. A system for intelligent real time information service comprising:
a transportation including a transportation data processing unit; an orientation system, a transportation communication system, and at least one multimedia display units being respectively connected to said transportation data processing unit; wherein, said transportation data processing unit receiving a piece of real time surrounding information from said orientation system allowing said real time surrounding information to be established on said transportation, so that said transportation communication system would be applied to receive and transmit said information; said multimedia display unit could display said real time information that is processed and decoded by said transportation data processing unit; and
a service center including a service data processing unit to receive, process, and employ a received data; said service data processing unit further connecting with a service communication system, a multimedia processing unit, and a main database for a main system; wherein, said service communication system being employed to receive and transmit data, said multimedia processing unit being employed to process multimedia data, and said main database being employed to establish said real time information surrounding said transportation, instant information, and related conditional factors that are going to be supplied;
wherein, said real time information that is established by said orientation system would be transmitted to said service center via said transportation; thence said service center would access said real time information in said main database for said service data processing unit to compare said established information with said accessed information; a compared result would be accordingly transmitted to said service communication system, and said transportation data processing unit would transmit the received data from said service communication system to said correspondent multimedia display unit after processed and decoded, so that an appropriate service with said real time information could be provided.

10. The system as claimed in claim 9, wherein, said multimedia display unit further includes a driver displayer, a customer displayer, and a third party displayer.

11. The system as claimed in claim 10, wherein, said third party displayer could offer said real time information to a staff outside said transportation.

12. The system as claimed in claim 9, wherein, said multimedia processing unit of said service center further connects to a multimedia processing platform; said platform could receive and process a piece of external multimedia information via Internet, so that after said multimedia information is processed by said multimedia processing unit, said multimedia information would be directly transmitted to said transportation via said service communicating system.

13. The system as claimed in claim 9, wherein, said multimedia processing unit of said service center further connects to a multimedia processing platform; said platform could receive and process a piece of external multimedia information via Internet, so that after said multimedia information is processed by said multimedia processing unit, said multimedia information would be transmitted to said transportation via a processing and employment of said service data processing unit.
